(19) United States
(12) Patent Application Publication
(10) Pub. No.: US 2026/0368744 A1
(43) Pub. Date: Nov. 19, 2026

(54) ARTIFICIAL INTELLIGENCE ASSISTED METHOD FOR CUSTOMER ONBOARDING

(71) Applicant: Honeywell International Inc., Charlotte, NC (US)

(72) Inventors: Aaron Dsouza, Alpharetta, GA (US); Abhin Pai, Dunwoody, GA (US); Arunkumar Anand, Dunwoody, GA (US); Harshit Tiwari, Atlanta, GA (US); Venkatachal Musigeri, Atlanta, GA (US)

(21) Appl. No.: 19/200,751

(22) Filed: May 7, 2025

(51) Int. Cl. G06Q 30/01; G06F 16/93

(52) U.S. Cl. CPC G06Q 30/01; G06F 16/93

(57) ABSTRACT

An AI assisted method and system for customer onboarding is disclosed. The method includes receiving, from a plurality of sources, a plurality of documents of different formats including details of location and operation of a plurality of assets at a site. Terminologies present in the documents are standardized by analyzing the documents against a Common Data Model (CDM) ontology. A spatial hierarchy of the site is generated and the assets operating at the site are identified. Asset instances are created corresponding to the assets, and functional relations within operational configurations of the assets and relations between the assets are determined. A template is selected for storing details of the spatial hierarchy of the site, the assets, and the functional relations. A digital twin is created by aggregating the details of the spatial hierarchy of the site, the assets, and the functional relations. The digital twin assists in customer onboarding.

### TECHNICAL FIELD

Present disclosure relates to customer onboarding, and more specifically relates to a system and a method of customer onboarding using artificial intelligence/machine learning.

### BACKGROUND

Within any industry, to provide a service to a customer i.e. an enterprise, a detailed understanding of processes running at the customer's end is required. These processes are generally implemented through different machines and sensors. To obtain understanding of the processes, several documents are shared with a service provider, and service contracts are finalized based on the understanding. Finally, the service is brought live and made available to the customer for use.

Several hurdles lie within the task of developing an understanding of the processes. Conventionally, such task is performed completely in a manual manner. Handling vast unstructured data from varied sources is a complex and inefficient process, and often results in collection of incomplete, inconsistent, and redundant information related to the processes. Further, unique terminologies don't match with nomenclature used in the different documents and are hard to interpret. Therefore, the task of developing an understanding of the processes is time-consuming and error-prone.

Thus, a system and a method of addressing the above-mentioned challenges are needed.

### SUMMARY OF THE INVENTION

In one embodiment, a method of implementing an Artificial Intelligence (AI) assisted method for customer onboarding is described. The method includes receiving, from a plurality of sources, a plurality of documents of different formats including details of location and operation of a plurality of assets at a site. The documents include Building Information Modeling (BIM) files, floor plans, user manual, tag lists, and mail communications. The method further includes standardizing, by an AI agent, terminologies present in the documents by analyzing the documents against a Common Data Model (CDM) ontology. The method further includes generating, by the AI agent, a spatial hierarchy of the site using one or more of the plurality of documents and user inputs. The method further includes identifying, by the AI agent, the assets operating at the site based on one or more of the plurality of documents and the user inputs. The method further includes creating, by the AI agent, one or more asset instances corresponding to the assets, wherein each asset instance includes operational configurations and schematics of an asset. The method further includes determining, by the AI agent, functional relations within operational configurations of the assets and relations between the assets. The method further includes selecting, by the AI agent, a template from a plurality of predefined templates for storing details of the spatial hierarchy of the site, the assets, and the functional relations. The method further includes creating, by the AI agent, a digital twin by aggregating the details of the spatial hierarchy of the site, the assets, and the functional relations. The digital twin assists in customer onboarding.

In an aspect, the documents are mapped to the plurality of sources for enabling traceability, checking consistency, and identifying data redundancy.

In an aspect, a User Interface (UI) is provided for accessing the digital twin for guiding a user for the customer onboarding.

In an aspect, development of the digital twin is continuously tracked and an update is provided to a user.

In an aspect, a feedback is received from review of each stage of the method.

In an aspect, the digital twin is updated in response to the feedback from the review.

In an aspect, a single asset instance is created for identical assets.

In an aspect, the AI agent is a Large Language Model (LLM) utilizing Retrieval-Augmented Generation (RAG).

In one embodiment, a system for implementing an AI assisted method for customer onboarding is described. The system comprises a processor and a memory coupled with the memory. The memory stores program instructions configured to receive, from a plurality of sources, a plurality of documents of different formats including details of location and operation of a plurality of assets at a site. The documents include BIM files, floor plans, user manual, tag lists, and mail communications. The memory further stores program instructions configured to standardize, by an AI agent, terminologies present in the documents by analyzing the documents against a CDM ontology. The memory further stores program instructions configured to generate, by the AI agent, a spatial hierarchy of the site using one or more of the plurality of documents and user inputs. The memory further stores program instructions configured to identify, by the AI agent, the assets operating at the site based on one or more of the plurality of documents and the user inputs. The memory further stores program instructions configured to create, by the AI agent, one or more asset instances corresponding to the assets, wherein each asset instance includes operational configurations and schematics of an asset. The memory further stores program instructions configured to determine, by the AI agent, functional relations within operational configurations of the assets and relations between the assets. The memory further stores program instructions configured to select, by the AI agent, a template from a plurality of predefined templates for storing details of the spatial hierarchy of the site, the assets, and the functional relations. The memory further stores program instructions configured to create, by the AI agent, a digital twin by aggregating the details of the spatial hierarchy of the site, the assets, and the functional relations. The digital twin assists in customer onboarding.

In an aspect, the memory further stores program instructions configured to map the documents to the plurality of sources for enabling traceability, checking consistency, and identifying data redundancy.

In an aspect, the memory further stores program instructions configured to provide a UI accessing the digital twin for guiding a user for the customer onboarding.

In an aspect, the memory further stores program instructions configured to continuously track development of the digital twin and providing an update to a user.

In an aspect, the memory further stores program instructions configured to receive a feedback from review of each stage of the method.

In an aspect, the memory further stores program instructions configured to update the digital twin in response to the feedback from the review.

In an aspect, a single asset instance is created for identical assets.

In an aspect, the AI agent is an LLM utilizing RAG.

In one embodiment, a non-transitory computer-readable storage medium for implementing an AI assisted method for customer onboarding is described. The non-transitory computer-readable storage medium comprises a computer program code for execution by one or more processors of an apparatus. The computer program code is configured to, when executed by the one or more processors, cause the apparatus to receive, from a plurality of sources, a plurality of documents of different formats including details of location and operation of a plurality of assets at a site. The documents include BIM files, floor plans, user manual, tag lists, and mail communications. The computer program code is further configured to standardize, by an AI agent, terminologies present in the documents by analyzing the documents against a CDM ontology. The computer program code is further configured to generate, by the AI agent, a spatial hierarchy of the site using one or more of the plurality of documents and user inputs. The computer program code is further configured to identify, by the AI agent, the assets operating at the site based on one or more of the plurality of documents and the user inputs. The computer program code is further configured to create, by the AI agent, one or more asset instances corresponding to the assets. Each asset instance includes operational configurations and schematics of an asset. The computer program code is further configured to determine, by the AI agent, functional relations within operational configurations of the assets and relations between the assets. The computer program code is further configured to select, by the AI agent, a template from a plurality of predefined templates for storing details of the spatial hierarchy of the site, the assets, and the functional relations. The computer program code is further configured to create, by the AI agent, a digital twin by aggregating the details of the spatial hierarchy of the site, the assets, and the functional relations, wherein the digital twin assists in customer onboarding.

In an aspect, the non-transitory computer-readable storage medium further comprises computer program code to cause the apparatus to map the documents to the plurality of sources for enabling traceability, checking consistency, and identifying data redundancy.

In an aspect, the non-transitory computer-readable storage medium further comprises computer program code to cause the apparatus to provide a UI accessing the digital twin for guiding a user for the customer onboarding.

In an aspect, the AI agent is an LLM utilizing RAG.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates a network architecture for implementing an Artificial Intelligence (AI) assisted method for customer onboarding, in accordance with an embodiment of the present disclosure;

FIG. 2 illustrates a block diagram of an example computing device for implementing an AI assisted method for customer onboarding, in accordance with an embodiment of the present disclosure;

FIG. 3 illustrates a block diagram of the computing device storing program instructions for implementing an AI assisted method for customer onboarding, in accordance with an embodiment of the present disclosure;

FIG. 4a illustrates a textual representation of a BIM file, in accordance with an embodiment of the present disclosure;

FIG. 4b illustrates a visual representation of a portion of the BIM file, in accordance with an embodiment of the present disclosure;

FIG. 5 illustrates a schematic representation of the CDM ontology, in accordance with an embodiment of the present disclosure;

FIG. 6 illustrates a schematic representation of a portion of the asset ontology, in accordance with an embodiment of the present disclosure;

FIG. 7 illustrates a schematic representation of the spatial hierarchy, in accordance with an embodiment of the present disclosure;

FIG. 8 illustrates a relation diagram showing different details stored in an asset instance, in accordance with an embodiment of the present disclosure; and

FIGS. 9a and 9b cumulatively illustrate a flow chart of an AI assisted method for customer onboarding, in accordance with an embodiment of the present disclosure.

### DETAILED DESCRIPTION OF THE INVENTION

The present disclosure provides a system and a method of implementing an Artificial Intelligence (AI) assisted method for customer onboarding. The method includes receiving, from a plurality of sources, a plurality of documents of different formats including details of location and operation of a plurality of assets at a site. The documents include Building Information Modeling (BIM) files, floor plans, user manual, tag lists, and mail communications. An Artificial Intelligence (AI) agent standardizes terminologies present in the documents by analyzing the documents against a Common Data Model (CDM) ontology. The AI agent generates a spatial hierarchy of the site using one or more of the plurality of documents and user inputs. The AI agent identifies the assets operating at the site based on one or more of the plurality of documents and the user inputs. The AI agent creates one or more asset instances corresponding to the assets. Each asset instance includes operational configurations and schematics of an asset. The AI agent determines functional relations within operational configurations of the assets and relations between the assets. The AI agent selects a template from a plurality of predefined templates for storing details of the spatial hierarchy of the site, the assets, and the functional relations. The AI agent creates a digital twin by aggregating the details of the spatial hierarchy of the site, the assets, and the functional relations. The digital twin assists in customer onboarding.

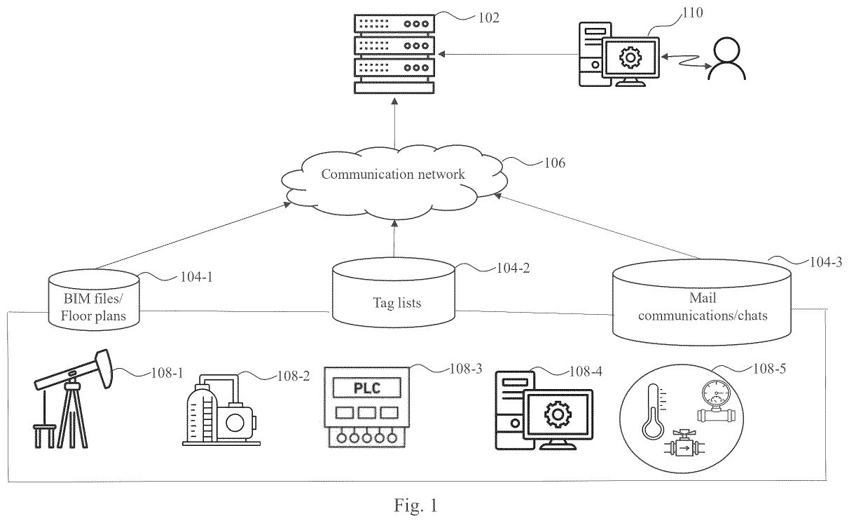

Present disclosure provides an Artificial Intelligence (AI) assisted method for customer onboarding. FIG. 1 illustrates a network architecture of a system 102 for implementing an Artificial Intelligence (AI) assisted method for customer onboarding, in accordance with an embodiment of the present disclosure. The system 102 may host an AI based service for providing assistance in customer onboarding. The system 102 may be a data processing device, such as a server 102 implemented over a cloud network. The server 102 may be connected with different data sources 104 through a communication network 106.

The communication network 106 may be a wired and/or a wireless network. The communication network 106 may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art.

The communication network 106 may utilize network components to establish connection between the server 102 and the data sources 104. The network components may include, hubs, switches, routers, bridges, and repeaters. The routers may be of different types such as Provide Edge (PE) routers, Customer Edge (CE) routers, and intermediate routers. The switches and the routers are primary network components, wherein the switches are used to connect the user device present within a network, and the routers are used to connect multiple networks.

The data sources 104 may include (BIM) files and floor plans 104-1, user manual, tag lists 104-2, and mail communications and chats 104-3. The data sources 104 hold information related to several assets 108 operating at a site. The assets 108 may correspond to different machineries and sensors, such as a crude oil extraction unit 108-1, an industrial boiler 108-2, a Programmable Logic Control (PLC) unit 108-3, a workstation 108-4, and sensors 108-5. The sensors 108-5 may include temperature sensors, pressure sensors, motion sensors, light sensors, humidity sensors, gas sensors, load sensors, flow sensors, and image sensors. The sensors 108-5 may be used for monitoring values of certain parameters, such as pressure values over a particular time period, position of pressure control valves, functional status of the pressure control valves, etc. The system 102 may also be connected with a user device 110 accessible by an operator for providing manual feedback during operation of the system 102.

An AI agent running at the system 102 may perform several steps for providing assistance in customer onboarding. In one implementation, the AI agent may be a Large Language Model (LLM) utilizing Retrieval-Augmented Generation (RAG). To proceed operation, the system 102 receives a plurality of documents of different formats from the data sources 104. The documents include details of location and operation of a plurality of assets at a site, for example the assets 104. The AI agent may map the documents to the corresponding sources for enabling traceability, checking consistency, and identifying data redundancy.

Before initiating processing of the documents, the AI agent may standardize terminologies present in the documents by analyzing the documents against a Common Data Model (CDM) ontology. Thereafter, the AI agent may process the documents to generate a spatial hierarchy of the site. Further, the AI agent may also identify the assets 104 operating at the site, through processing of the documents. Post identifying the assets, the AI agent may create asset instances. Each asset instance is a software entity representative of an asset and include operational configurations and schematics of the asset. A single asset instance may be created for identical assets. For example, a single asset instance could be created to represent an industrial boiler and the same asset instance could be replicated for representing other industrial boilers having similar configurations.

Successively, the AI agent may determine functional relations within operational configurations of the assets and relations between the assets. The functional relations may be defined as mathematical relations/formulae. For example, a formulae may define relation of volume of hot water provided by an industrial boiler with volume of cool inlet water and heating capacity of the industrial boiler.

Thereafter, the AI agent may select a template from a plurality of predefined templates, for storing details of the spatial hierarchy of the site, the assets, and the formulae.

The AI agent may aggregate all the information i.e. the details of the spatial hierarchy of the site, the assets, and the formulae to generate a digital twin for the site. Though the AI agent provides assistance at all stages during development of the digital twin, the operator performs manual review and provides feedback at each stage. The digital twin is continuously updated in response to the feedback from the manual review. The digital twin thus developed by the system 102 can be used for customer onboarding.

By implementing the above-described functionality, the system leverages an AI agent to process several documents to develop a digital twin useable for customer onboarding.

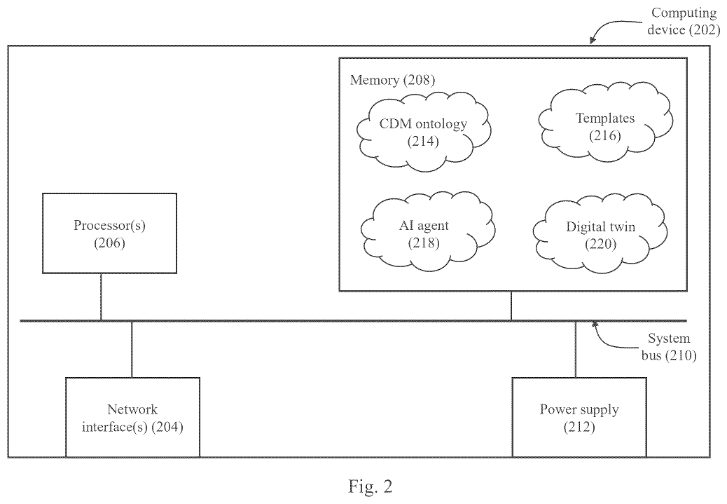

FIG. 2 illustrates a block diagram of an example computing device 202 (similar to the system 102) for implementing an AI assisted method for customer onboarding, in accordance with an embodiment of the present disclosure. The computing device 202 may be implemented over a cloud network. The computing device 202 may comprise one or more network interfaces 204 (e.g., wired, wireless, etc.), at least one processor 206, a memory 208 interconnected by a system bus 210, and a power supply 212.

The one or more network interfaces 204 may be used to provide input or fetch output from the computing device 202. The one or more network interfaces 204 may be implemented as a Command Line Interface (CLI) or a Graphical User Interface (GUI). Further, Application Programming Interfaces (APIs) may also be used for remotely interacting with edge systems and cloud servers.

The processor 206 may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

The memory 208 may include, but is not limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The memory 208 comprises a plurality of storage locations that are addressable by the processor 206 and the network interfaces 204 for storing software programs and other necessary information associated with the embodiments described herein. For example, the memory 208 stores a Common Data Model (CDM) ontology 214, predefined templates 216 for storing details of sites and assets, executable version of an AI agent 218 and a digital twin 220. The processor 206 may comprise hardware elements or hardware logic adapted to execute the software programs and manipulate data structures.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

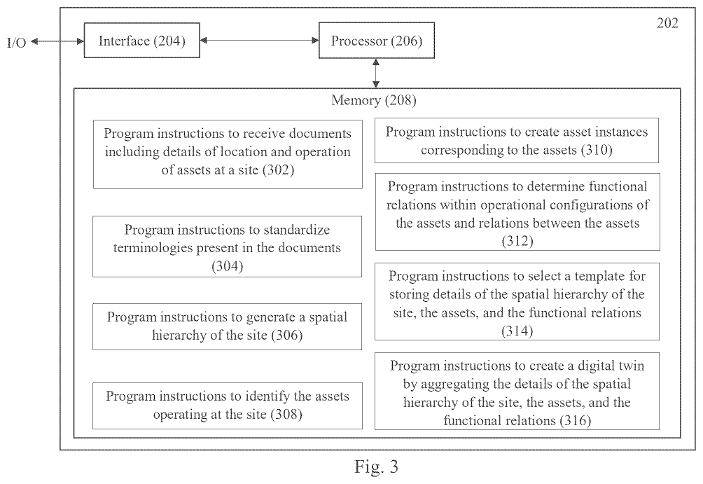

FIG. 3 illustrates a block diagram of the computing device 202 storing program instructions for implementing the AI assisted method for customer onboarding, in accordance with an embodiment of the present disclosure. The memory 208 of the computing device 202 may store program instructions for performing several functions associated with management of the services. Functional code stored in the memory 208 may include program instructions to receive documents including details of location and operation of assets at a site 302, program instructions to standardize terminologies present in the documents 304, program instructions to generate a spatial hierarchy of the site 306, program instructions to identify the assets operating at the site 308, program instructions to create asset instances corresponding to the assets 310, program instructions to determine functional relations within operational configurations of the assets and relations between the assets 312, program instructions to select a template for storing details of the spatial hierarchy of the site, the assets, and the functional relations 314, and program instructions to create a digital twin by aggregating the details of the spatial hierarchy of the site, the assets, and the functional relations 316.

The program instructions to receive documents including details of location and operation of assets at a site 302 may cause the processor 206 to receive a plurality of documents of different formats from a plurality of sources. The plurality of documents include details of location and operation of a plurality of assets at a site, wherein the documents include Building Information Modeling (BIM) files, floor plans, user manual, tag lists, and mail communications. The program instructions to standardize terminologies present in the documents 304 may cause the processor 206 to standardize terminologies present in the documents by analyzing the documents against a Common Data Model (CDM) ontology. The program instructions to generate a spatial hierarchy of the site 306 may cause the processor 206 to generate a spatial hierarchy of the site using one or more of the plurality of documents and user inputs.

The program instructions to identify the assets operating at the site 308 may cause the processor 206 to identify the assets operating at the site based on one or more of the plurality of documents and the user inputs. The program instructions to create asset instances corresponding to the assets 310 may cause the processor 206 to create one or more asset instances corresponding to the assets. Each asset instance includes operational configurations and schematics of an asset.

The program instructions to determine functional relations within operational configurations of the assets and relations between the assets 312 may cause the processor 206 to determine functional relations within operational configurations of the assets and relations between the assets. The program instructions to select a template for storing details of the spatial hierarchy of the site, the assets, and the functional relations 314 may cause the processor 206 to select a template from a plurality of predefined templates for storing details of the spatial hierarchy of the site, the assets, and the functional relations. The program instructions to create a digital twin by aggregating the details of the spatial hierarchy of the site, the assets, and the functional relations 316 may cause the processor 206 to create a digital twin by aggregating the details of the spatial hierarchy of the site, the assets, and the functional relations. The digital twin assists in customer onboarding.

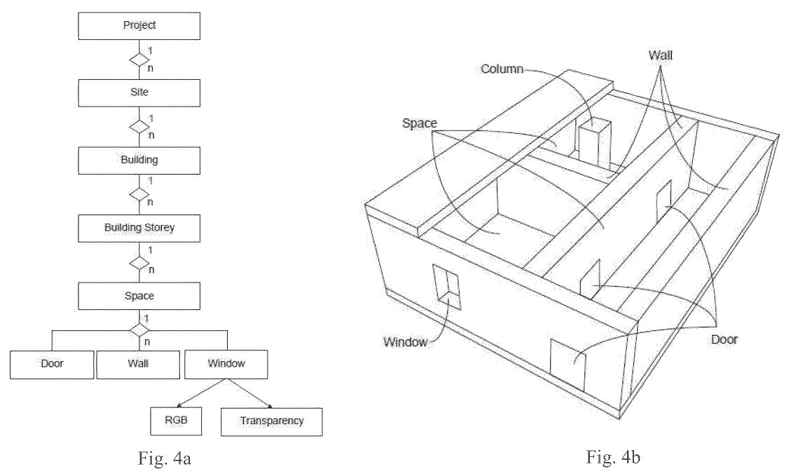

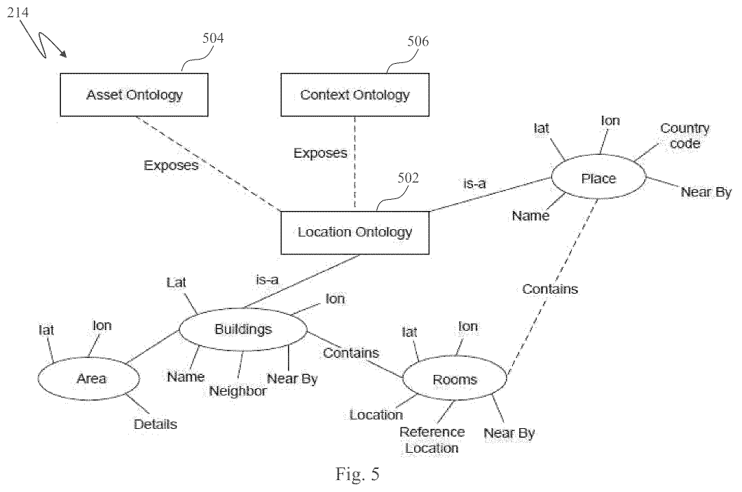

A detailed explanation of the AI assisted method for customer onboarding is provided successively with reference to FIGS. 4 through 9.

The AI assisted method begins with the system 102 receiving a plurality of documents of different formats from a plurality of sources. The plurality of documents may include details of location and operation of a plurality of assets at a site. The documents may include, but are not limited to, Building Information Modeling (BIM) files, floor plans, user manual, tag lists, and mail communications.

The BIM files are digital representations of physical and functional characteristics of a building. The BIM files include detailed information about a building's design, construction, and operational components. Essentially, the BIM files include details of 3D geometry represents physical components of a building, such as walls, windows, doors, roofs, etc. The BIM files also include metadata i.e. non-graphical data about the building, such as materials, dimensions, cost estimates, schedules, and manufacturer details. The BIM files also include energy details helping to optimize heating, ventilation, and air conditioning (HVAC) systems, as well as overall energy usage.

FIG. 4a illustrates a textual representation of a BIM file and FIG. 4b illustrates a visual representation of a portion of the BIM file, in accordance with an embodiment of the present disclosure. As shown in FIG. 4a, a project includes up to ‘n’ sites, a site includes up to ‘n’ buildings, a building includes up to ‘n’ storey/floors, a storey includes up to ‘n’ spaces, a space includes up to ‘n’ doors, walls, and windows, a window may have an RGB color or may be transparent. FIG. 4b illustrates a visual representation of a floor of a building. The visual representation shows position and count of different elements like doors, walls, and windows.

The system 102 maps each document to a respective source for enabling traceability, checking consistency, and identifying data redundancy. For mapping each document to its respective source, the system 102 performs multiple steps. At first, the system 102 identifies an original source, which could be a file, database, template, API, or reference material. The system 102 then defines the relationship i.e. establishes how the document content relates to the source. The system 102 tracks changes in the source. If the source changes, the document may need to be updated accordingly (e.g., in CMS or database systems). Thereafter, the system 102 documents the mapping. The mapping may involve setting up metadata or annotations to keep track of the source of the document.

After mapping each document to its respective source, the system 102 implements the AI agent 218 to standardize terminologies present in the documents. The AI agent 218 standardizes the terminologies by analyzing the documents against a Common Data Model (CDM) ontology 214. Standardization of the terminologies is required because details of sites and assets may be mentioned in different forms in the documents. For example, a first document may provide details of position of a burner. A second document may provide operational details of an incinerator. It would not be generally possible to understand that the burner and the incinerator refer to same device. In such situations, the the system 102 refers to the CDM ontology 214. The CDM ontology 214 is a standardized structure that defines relationships, concepts, and categories of data within a specific domain, enabling interoperability and data sharing across different systems, platforms, or applications. The CDM ontology 214 provides a shared vocabulary, data definitions, and classifications that allow various systems or organizations to understand and exchange data in a consistent manner. The CDM ontology 214 ensures that data from different sources can be aligned, integrated, and interpreted uniformly.

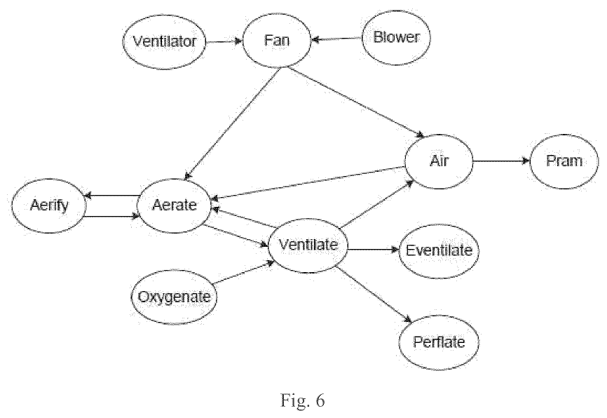

FIG. 5 illustrates a schematic representation of the CDM ontology 214, in accordance with an embodiment of the present disclosure. The CDM ontology 214 includes a location ontology 502, an asset ontology 504, and a context ontology 506. As shown in FIG. 5, the location ontology 502 includes details of different places, areas, building, and rooms, and their associations. For example, for a building, a name, neighboring landmark (neighbor), nearby area, latitude coordinate (lat), and longitude coordinate (lon) are stored. Further, rooms contained in the building and different properties of the rooms are also stored.

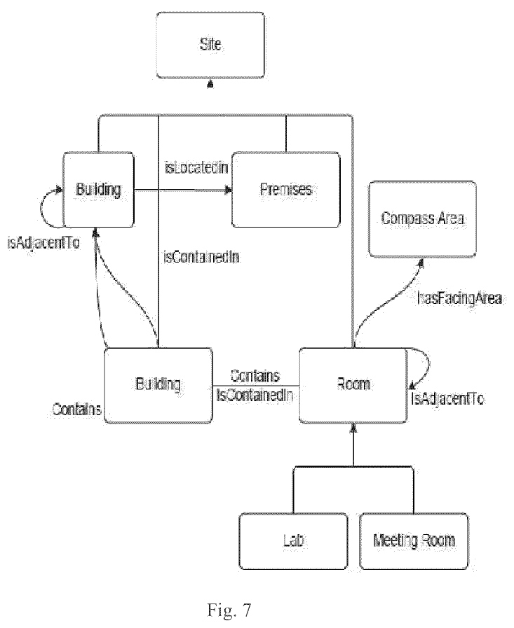

FIG. 6 illustrates a schematic representation of a portion of the asset ontology 502, in accordance with an embodiment of the present disclosure. As shown, the portion of the asset ontology 502 is related to a fan. The portion of the asset ontology 502 includes synonyms like blower and ventilator, and other associated words like ventilate, aerate, oxygenate. Similarly, the asset ontology 502 in entirety would include associations between details of different assets, their roles, properties, and other aspects.

After standardizing the terminologies present in the documents, the AI agent 218 generates a spatial hierarchy of the site. The AI agent 218 may generate the spatial hierarchy of the site using the plurality of documents and/or user inputs. The spatial hierarchy of the site refers to an arrangement or organization of different spaces and areas within a site. The spatial hierarchy can include different layers/spaces. For example, the spatial hierarchy may include primary spaces i.e. core or central spaces. These are the most significant or important areas within the site, often representing the main focus or focal point. In a building, for example, a primary space may be a lobby or a central atrium. The spatial hierarchy may also include secondary spaces i.e. transitional spaces. The secondary spaces help link primary spaces and guide people through the site. The secondary spaces include hallways, corridors, or staircases that connect more public areas to private or specialized spaces.

The spatial hierarchy may also include tertiary spaces i.e. private or specialized spaces. The tertiary spaces are more specialized areas within the site, often serving specific functions like offices, or storage rooms. The spatial hierarchy may also include transition zones. The transition zones are spaces that act as buffers between primary spaces and more private or secondary areas. These zones help to control the movement and access into different parts of the site. The spatial hierarchy may also include circulation routes, such as walkways and passageways.

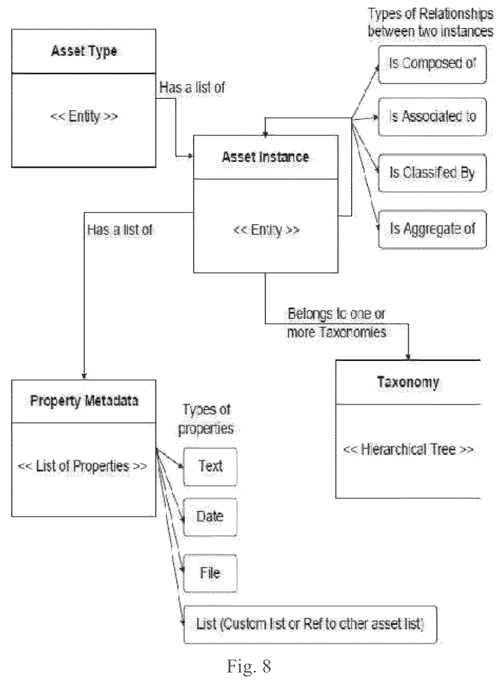

FIG. 7 illustrates a schematic representation of the spatial hierarchy, in accordance with an embodiment of the present disclosure. As shown, the spatial hierarchy provides a schematic representation of different areas in a site and the association between them. For example, it is shown that a building is located in a premise of a site, the building contains a floor, the floor contains a room, etc.

Successively, the AI agent 218 identifies the assets operating at the site based on the plurality of documents and/or the user inputs. For example, the AI agent 218 may identify the assets from the floor plan. The floor plan may include one or more details related to the assets, such as location of the assets, operation of the assets, and parameters associated with operation of the assets. The assets may include software systems, electrical machines, mechanical devices, chemical processing machineries, sensors, etc.

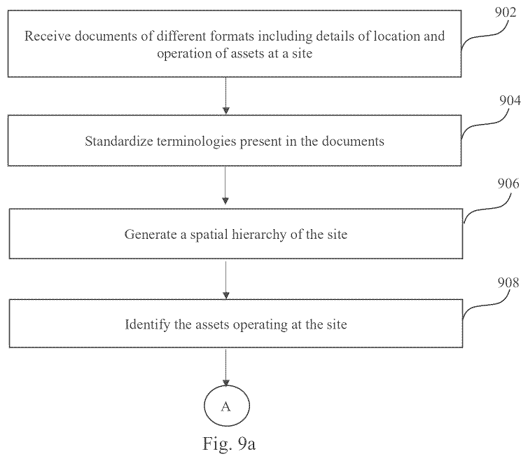

Post identification of the assets, the AI agent 218 creates one or more asset instances corresponding to the assets. Each asset instance includes operational configurations and schematics of an asset. An asset instance refers to a specific occurrence or object of an asset that is loaded, instantiated, or created within a program. FIG. 8 illustrates a relation diagram showing different details stored in an asset instance, in accordance with an embodiment of the present disclosure. Each asset instance may represent an asset i.e. a hardware element/machine operating in the site. For each asset, an asset type may be defined. For example, for a boiler, an asset type “heating device” may be defined. Further, a taxonomy may be defined for each asset. For example, for the boiler, the taxonomy may indicate that the boiler is a part of a water treatment process and leads/connected to a condensation unit. Further, property metadata may be defined for each asset. The property metadata may include text, date, file, or a custom list. For example, for the boiler, its specifications may be stored in the property metadata.

In one implementation, a single asset instance may be created for identical assets. Creation of a single asset instance for identical assets in a software system or database is important for consistency and increasing efficiency. Object-oriented programming (OOP) principles or database normalization techniques can be used to ensure that only one instance of the asset is created and referenced, even if multiple users or processes interact with it.

Post creating the asset instances corresponding to the assets, the AI agent 218 determines functional relations within operational configurations of the assets and relations between the assets. The functional relations may be defined as mathematical relations/formulae.

In one example, a formula defining energy balance for a boiler may be as mentioned below.

Qin=Qout+Qloss equation (1)

In above equation (1), “Qin” denotes energy input to the boiler (usually from fuel combustion), “Qout” denotes useful energy output (i.e., steam produced), and “Qloss” denotes heat losses due to radiation, convection, or incomplete combustion.

In another example, a heat transfer equation defining a boiler exchange rate may be as mentioned below.

Q=U·A·ΔT equation (2)

In above equation (2), “Q” denotes heat transfer rate (W), “U” denotes an overall heat transfer coefficient (W/m²·K), “A” denotes a surface area for heat exchange (m²), and “ΔT” denotes temperature difference between the fluid and the surrounding surfaces (K).

Successively, the AI agent 218 selects a template for storing details of the spatial hierarchy of the site, the assets, and the functional relations. The AI agent 218 selects the template from a plurality of predefined templates.

For example, a spatial hierarchy template may include below details.

| Field | Description |
|---|---|
| Site name | Name of the site (e.g., “Main Manufacturing Facility”) |
| Site ID | Unique identifier for the site |
| Site address | Physical address of the site (street, city, state, ZIP) |
| Site description | Brief description of the site and its purpose (e.g., |
| | manufacturing, research) |
| Site layout | Diagram or overview of the site's general layout |
| | (optional) |
| Site zones | List of zones or areas within the site (e.g., Zone 1 - |
| | Manufacturing, Zone 2 - Warehouse, etc.) |
| Zones | Breakdown of zones with details |

In another example, an asset template may include below details.

| Field | Description |
|---|---|
| Asset ID | Unique identifier for each asset (e.g., “A001” for |
| | Boiler, “A002” for Pump) |
| Asset name | Name of the asset (e.g., “Boiler”, “Conveyor |
| | Belt”) |
| Asset type | Type of the asset (e.g., Boiler, HVAC, Conveyor, |
| | Generator) |
| Location | Location of the asset on the site (e.g., “Zone 1 - |
| | Manufacturing, Room 102”) |
| Asset function | Description of the asset's function (e.g., “Heats |
| | water for the manufacturing process”) |
| Manufacturer | Name of the asset's manufacturer or supplier |
| Model/Serial number | Model or serial number of the asset |
| Installation date | Date when the asset was installed or |
| | commissioned |
| Asset status | Operational status (e.g., Active, Inactive, |
| | Under Maintenance, etc.) |
| Operational life | Expected operational life of the asset (in years |
| | or hours) |
| Maintenance schedule | Frequency of maintenance (e.g., quarterly, |
| | annually) |
| Last maintenance date | Date of last maintenance or checkup |
| Capacity/Performance | Specifications of the asset (e.g., output capacity, |
| specs | power, throughput, etc.) |
| Condition | Condition of the asset (e.g., New, Good, Fair, |
| | Needs Repair, etc.) |
| Functional | List of other assets dependent on or interacting |
| dependencies | with this asset (e.g., “Pump A relies on Boiler |
| | B for heating water”) |
| Criticality | Importance level of the asset (e.g., Critical, |
| | High, Medium, Low) |
| Asset owner | Department or person responsible for the asset |

Similarly, templates for storing a combination of details i.e. of both site, assets, and other entities may also be available for use. Alternatively, if a suitable template isn't available, it could be created by the user, and stored for future reference.

Finally, the AI agent 218 creates the digital twin 220 by aggregating the details of the spatial hierarchy of the site, the assets, and the functional relations. Because the digital twin 220 is created by aggregating the details of the spatial hierarchy of the site, the assets, and the functional relations, it could be said that creation of the digital twin 220 begins with receipt of the plurality of documents including details of the location and operation of the plurality of assets at the site. The system 102 provides a User Interface (UI), such as the interface 204 for a user to continuously track development of the digital twin 220. Based on the tracking, the user can provide feedback related to the development of the digital twin 220, at each stage. The digital twin 220 is updated based on the feedback received from the user, at each stage.

After development, the user may access the UI for using the digital twin 220. The user may utilize the digital twin 220 for enterprise customer onboarding. The digital twin 220 represents a comprehensive, dynamic virtual model of an enterprise, including its operations, workflows, systems, infrastructure, and customer interactions. Using the digital twin 220 for enterprise customer onboarding provides a highly personalized, data-driven, and streamlined approach to integrating new clients into a business process.

For enterprise customer onboarding, the digital twin 220 may offer one or more of the below mentioned features:
Streamlining data integration and sharing: The digital twin 220 assists in integrating and synchronizing customer data across various internal systems (e.g., CRM, ERP, HR systems) to ensure that all departments have real-time visibility into the customer's journey. For example, once an enterprise customer signs an agreement, the digital twin 220 can trigger workflows in the sales and customer success teams, providing them with tailored onboarding tasks, timelines, and expectations based on the customer's needs. In this manner, the digital twin 220 ensures that all relevant teams (sales, customer success, IT, product) have access to the same accurate and up-to-date information, reducing miscommunication and inefficiencies.
Tailoring onboarding processes to enterprise customers: The digital twin 220 allows for the creation of customized onboarding workflows that are automatically adjusted based on the customer's business requirements, the products they've purchased, and their specific needs. For example, a customer onboarding a large-scale enterprise resource planning (ERP) system may need specialized technical support, while a customer onboarding a software-as-a-service (SaaS) product might need integration assistance and user training. Tailoring workflows for enterprise customers enhance their experience, making the onboarding process smoother, faster, and more relevant to their needs.
Real-time tracking and monitoring of customer onboarding progress: As the customer moves through the onboarding process, the digital twin 220 can monitor progress in real-time, tracking milestones such as account setup, product configuration, user training, integration with existing enterprise systems, and communication and feedback from the customer. In this manner, the digital twin 220 provides managers and teams with a clear, up-to-date view of each customer's onboarding status, allowing for quick adjustments and proactive support.
Automated Alerts and Notifications for Teams: The digital twin 220 generates automated alerts or notifications for relevant teams based on the customer's status or behavior during onboarding. If a customer is encountering issues with integration, the system can trigger an alert to the technical support team. If a customer is late in completing a required step, automated reminders or follow-up emails can be sent to guide them back on track. Automated notifications help ensure that the customer's onboarding experience remains smooth and that all involved teams are aware of their responsibilities, improving efficiency and customer satisfaction.
Feedback and continuous improvement: After the onboarding process, the digital twin 220 continues to track the customer's usage and collect feedback on the process, identifying areas for improvement in the onboarding flow. For example, feedback on the ease of integration or training can be analyzed to enhance future customer onboarding processes. Continuous feedback loops provide insights into how the onboarding experience can be improved over time, helping the enterprise refine its approach for future customers.

The AI agent 218 executing over the system 102 is a software entity implemented using AI techniques to perceive its environment, process information, make decisions, and perform actions in an autonomous or semi-autonomous manner. In one implementation, the AI agent 218 is a Large Language Model (LLM) utilizing Retrieval-Augmented Generation (RAG). RAG is a hybrid approach that combines retrieval-based methods (such as search engines or knowledge bases) with generative models (like GPT-based models).

At an architecture level, a typical RAG-based system includes two key components, a retriever and a generator. The retriever is responsible for fetching relevant information from a large external knowledge base, document corpus, or indexed data. This component typically uses retrieval algorithms (like BM25, dense retrievers, or vector search) to retrieve contextually relevant documents based on the query. The generator is typically an LLM such as GPT, T5, or BART. The generator uses the retrieved documents as additional context and generates a response or output based on both the input query and the retrieved information.

Operation of a RAG involves the below described steps.

Step 1 involves providing a query/input to a RAG system. At this step, a user inputs a question or a query, for example “What is the operational state of boiler K350”.

Step 2 involves information retrieval. At this step, a retriever searches through a pre-built knowledge base or document corpus for relevant information. This can be done using two main types of retrieval models:
Sparse Retrieval (traditional methods like BM25 or TF-IDF): These methods focus on term matching between the query and documents.
Dense Retrieval (embedding-based models): The query is embedded in a high-dimensional vector space, and the retrieval system looks for documents whose embeddings are closest to the query's embedding.

Step 3 involves document ranking and selection. At this step, after retrieving a set of candidate documents, the retriever ranks them based on relevance. The top-N documents (e.g., the top 5 or 10 most relevant documents) are selected for the next step. In certain implementations, multi-stage retrieval is used to first narrow down the results to a smaller subset of documents before ranking them.

Step 4 involves feeding retrieved information to the generator. At this step, the generator receives both the original query and the top-N retrieved documents as input. The documents can either be concatenated with the query or used in a more sophisticated way, such as conditioning the model's generation on the context provided by these documents.

Step 5 involves generation of response. At this step, the generator (such as a fine-tuned GPT or BART model) processes the query along with the retrieved documents to produce a response. The model uses the context provided by the documents to generate a more informed and accurate answer.

Step 6 involves post-processing and output generation. At this step, after generating the response, the output is post-processed for grammar, fluency, or length check. Finally, a response is provided to the user.

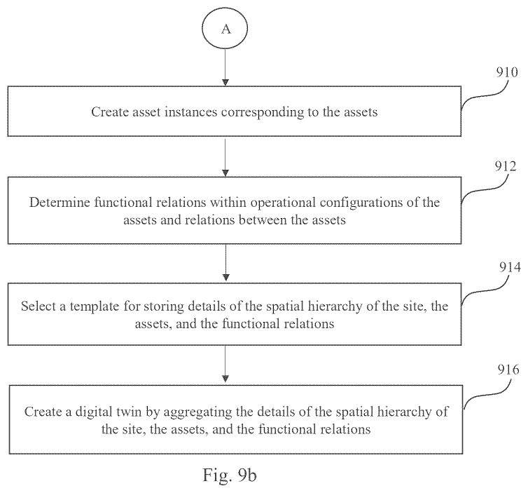

FIGS. 9a and 9b cumulatively illustrate a flow chart of an AI assisted method for customer onboarding, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIGS. 9a and 9b may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

At step 902, documents of different formats including details of location and operation of assets at a site are received from a plurality of sources. The documents include, but are not limited to, Building Information Modeling (BIM) files, floor plans, user manual, tag lists, and mail communications. The documents are mapped to the plurality of sources for enabling traceability, checking consistency, and identifying data redundancy.

At step 904, terminologies present in the documents are standardized. The terminologies are standardized by analyzing the documents against a Common Data Model (CDM) ontology. Standardization of the terminologies is required because details of sites and assets may be mentioned in different forms in the documents. The CDM ontology is a standardized structure that defines relationships, concepts, and categories of data within a specific domain, enabling interoperability and data sharing across different systems, platforms, or applications. The CDM ontology provides a shared vocabulary, data definitions, and classifications that allow various systems or organizations to understand and exchange data in a consistent manner. The CDM ontology ensures that data from different sources can be aligned, integrated, and interpreted uniformly.

At step 906, a spatial hierarchy of the site is generated using one or more of the plurality of documents and user inputs. The spatial hierarchy of the site refers to an arrangement or organization of different spaces and areas within a site. The spatial hierarchy can include different layers/spaces. For example, the spatial hierarchy may include primary spaces (core or central spaces), secondary spaces (transitional spaces), tertiary spaces (private or specialized spaces), transition zones, and circulation routes.

At step 908, the assets operating at the site are identified site based on the documents and/or the user inputs. For example, the assets may be identified from the floor plan. The floor plan may include one or more details related to the assets, such as location of the assets, operation of the assets, and parameters associated with operation of the assets. The assets may include software systems, electrical machines, mechanical devices, chemical processing machineries, sensors, etc.

At step 910, asset instances corresponding to the assets are created. Each asset instance includes operational configurations and schematics of an asset. An asset instance refers to a specific occurrence or object of an asset that is loaded, instantiated, or created within a program. A single asset instance is created for identical assets. Creation of a single asset instance for identical assets in a software system or database is important for consistency and increasing efficiency. Object-oriented programming (OOP) principles or database normalization techniques can be used to ensure that only one instance of the asset is created and referenced, even if multiple users or processes interact with it.

At step 912, functional relations within operational configurations of the assets and relations between the assets are determined. The functional relations may be defined as mathematical relations/formulae.

At step 914, a template is selected for storing details of the spatial hierarchy of the site, the assets, and the functional relations. The template is selected from a plurality of predefined templates.

At step 916, a digital twin is created by aggregating the details of the spatial hierarchy of the site, the assets, and the functional relations. The digital twin assists a user in customer onboarding. The digital twin can be accessed through a User Interface (UI).

Present disclosure described above with reference to one or more embodiments provides several technical advantages as mentioned successively. Proposed system utilizes AI agents such as Large Language Models (LLMs) to understand details of operational assets and processes running at customer's site and develop a digital twin based on the understanding. The digital twin allows seamless onboarding of the customer and drastically reduces the manual efforts.

The assets reference in present disclosure may be of different types depending on a type of enterprise for which the proposed system and method is implemented. For example, the asset may be a manufacturing machinery, such as a Computerized Numeric Control (CNC) machine, lathe, or milling machine. The machinery could also be a construction machinery, such as excavator, bulldozer, or crane. The asset could also be an agricultural machinery like tractor, harvester, or plow. The asset could also be a mining machinery like dragline, continuous miner, or a dump truck. The asset could also be a food processing machinery like a mixer, packaging machines, or a pasteurizer. The asset could also be a textile machinery like a spinning machine, weaving loom, or a knitting machine. The asset could also be a printing machinery like an offset printing press, digital printer, or a screen-printing machine. The asset could also be a woodworking machinery like a saw, planer, or a sander.

In an Information Technology (IT) enterprise, the asset may be a server like a web server or a database server. The asset may also be a workstation like a graphics workstation or a CAD workstations. The asset may also be a personal computer like a desktop or a laptop. The asset may also be a network device like a router or a network switch. The asset may also be a storage device like a Hard Disk Drive (HDD), Solid State Drive (SSD), or a Network Attached Storage (NAS). The asset may also be a mainframe, supercomputer, or a thin client. The asset may also be an embedded system like an Internet of Things (IoT) device or an industrial control system. The asset may also be a networking equipment like firewall or access point.

The term cloud network or network cloud referenced above refers to the integration of networking and cloud computing, allowing users to access, store, and manage data and applications over the internet rather than relying solely on local servers or personal devices. Network clouds enable scalability, flexibility, and cost efficiency in managing IT resources. The can be public clouds, private clouds, hybrid clouds, and multi-clouds. Through the public clouds, services are delivered over the internet and shared across multiple organizations. Providers like Amazon Web Services (AWS), Microsoft Azure, and Google Cloud Platform (GCP) offer resources that are accessible to anyone who wants to use them. The private clouds are available for exclusive use by an organization, offering greater control over data, security, and compliance. The private clouds can be hosted on-premises or by a third-party provider. The hybrid clouds combine public and private clouds, allowing data and applications to be shared between them. Organizations can maintain sensitive data on a private cloud while leveraging the scalability of a public cloud for less sensitive workloads. The multi-clouds involve using services from multiple cloud providers, which can include public, private, or hybrid clouds. Organizations may choose this approach to avoid vendor lock-in and to leverage the best services from different providers. The network clouds may provide Infrastructure as a Service (IaaS), Platform as a Service (PaaS), or Software as a Service (SaaS).

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

Those skilled in the art will understand that any number of nodes, devices, links, etc. may be used in the cloud network, and that the view shown herein is for simplicity. Also, those skilled in the art will further understand that while the cloud network is shown in a certain orientation, the cloud network is merely an example illustration that is not meant to limit the disclosure. For example, “real-world” cloud networks may comprise any type of network, including, among others, Fog networks, IoT networks, core networks, backbone networks, data centers, enterprise networks, provider networks, customer networks, virtualized networks (e.g., virtual private networks or “VPNs”), combinations thereof, and so on. Note further that the network environments and their associated devices may also be located in different geographic locations.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set as claimed in claims that issue from this application, in the specific form in which such claims issue, including any subsequent correction.

1. A method comprising:
receiving, from a plurality of sources, a plurality of documents of different formats including details of location and operation of a plurality of assets at a site, wherein the documents include Building Information Modeling (BIM) files, floor plans, user manual, tag lists, and mail communications;
standardizing, by an Artificial Intelligence (AI) agent, terminologies present in the documents by analyzing the documents against a Common Data Model (CDM) ontology;
generating, by the AI agent, a spatial hierarchy of the site using one or more of the plurality of documents and user inputs;
identifying, by the AI agent, the assets operating at the site based on one or more of the plurality of documents and the user inputs;
creating, by the AI agent, one or more asset instances corresponding to the assets, wherein each asset instance includes operational configurations and schematics of a corresponding asset;
determining, by the AI agent, functional relations within operational configurations of the assets and relations between the assets, wherein the functional relations are determined based on one or more operational parameters of the assets, the one or more operational parameters comprising an output quantity of a first asset of the assets, an input quantity of the first asset, and a capacity of the first asset;
selecting, by the AI agent, a template from a plurality of predefined templates for storing details of the spatial hierarchy of the site, the assets, and the functional relations; and
creating, by the AI agent, a digital twin by aggregating the details of the spatial hierarchy of the site, the assets, and the functional relations, wherein the digital twin assists in customer onboarding.

2. The method as claimed in claim 1, further comprising mapping the documents to the plurality of sources for enabling traceability, checking consistency, and identifying data redundancy.

3. The method as claimed in claim 1, further comprising providing a User Interface (UI) accessing the digital twin for guiding a user for the customer onboarding.

4. The method as claimed in claim 1, further comprising continuously tracking development of the digital twin and providing an update to a user.

5. The method as claimed in claim 1, further comprising receiving feedback from review of each stage of the method.

6. The method as claimed in claim 5, further comprising updating the digital twin in response to the feedback from the review.

7. The method as claimed in claim 1, wherein a single asset instance is created for identical assets.

8. The method as claimed in claim 1, wherein the AI agent is a Large Language Model (LLM) utilizing Retrieval-Augmented Generation (RAG).

9. A system comprising:
a processor; and
a memory coupled with the processor, wherein the memory stores program instructions configured to:
receive, from a plurality of sources, a plurality of documents of different formats including details of location and operation of a plurality of assets at a site, wherein the documents include Building Information Modeling (BIM) files, floor plans, user manual, tag lists, and mail communications;
standardize, by an AI agent, terminologies present in the documents by analyzing the documents against a Common Data Model (CDM) ontology;
generate, by the AI agent, a spatial hierarchy of the site using one or more of the plurality of documents and user inputs;
identify, by the AI agent, the assets operating at the site based on one or more of the plurality of documents and the user inputs;
create, by the AI agent, one or more asset instances corresponding to the assets, wherein each asset instance includes operational configurations and schematics of a corresponding asset;
determine, by the AI agent, functional relations within operational configurations of the assets and relations between the assets, wherein the functional relations are determined based on one or more operational parameters of the assets, the one or more operational parameters comprising an output quantity of a first asset of the assets, an input quantity of the first asset, and a capacity of the first asset;
select, by the AI agent, a template from a plurality of predefined templates for storing details of the spatial hierarchy of the site, the assets, and the functional relations; and
create, by the AI agent, a digital twin by aggregating the details of the spatial hierarchy of the site, the assets, and the functional relations, wherein the digital twin assists in customer onboarding.

10. The system as claimed in claim 9, wherein the memory further stores program instructions configured to map the documents to the plurality of sources for enabling traceability, checking consistency, and identifying data redundancy.

11. The system as claimed in claim 9, wherein the memory further stores program instructions configured to provide a User Interface (UI) accessing the digital twin for guiding a user for the customer onboarding.

12. The system as claimed in claim 9, wherein the memory further stores program instructions configured to continuously track development of the digital twin and provide an update to a user.

13. The system as claimed in claim 9, wherein the memory further stores program instructions configured to receive feedback from review of each stage.

14. (canceled)

15. The system as claimed in claim 9, wherein a single asset instance is created for identical assets.

16. The system as claimed in claim 9, wherein the AI agent is a Large Language Model (LLM) utilizing Retrieval-Augmented Generation (RAG).

17. A non-transitory computer-readable storage medium comprising computer program code for execution by one or more processors of an apparatus, the computer program code configured to, when executed by the one or more processors, cause the apparatus to:
receive, from a plurality of sources, a plurality of documents of different formats including details of location and operation of a plurality of assets at a site, wherein the documents include Building Information Modeling (BIM) files, floor plans, user manual, tag lists, and mail communications;
standardize, by an AI agent, terminologies present in the documents by analyzing the documents against a Common Data Model (CDM) ontology;
generate, by the AI agent, a spatial hierarchy of the site using one or more of the plurality of documents and user inputs;
identify, by the AI agent, the assets operating at the site based on one or more of the plurality of documents and the user inputs;
create, by the AI agent, one or more asset instances corresponding to the assets, wherein each asset instance includes operational configurations and schematics of a corresponding asset;
determine, by the AI agent, functional relations within operational configurations of the assets and relations between the assets, wherein the functional relations are determined based on one or more operational parameters of the assets, the one or more operational parameters comprising an output quantity of a first asset of the assets, an input quantity of the first asset, and a capacity of the first asset;
select, by the AI agent, a template from a plurality of predefined templates for storing details of the spatial hierarchy of the site, the assets, and the functional relations; and
create, by the AI agent, a digital twin by aggregating the details of the spatial hierarchy of the site, the assets, and the functional relations, wherein the digital twin assists in customer onboarding.

18. The non-transitory computer-readable storage medium as claimed in claim 17, further comprising computer program code to cause the apparatus to map the documents to the plurality of sources for enabling traceability, checking consistency, and identifying data redundancy.

19. The non-transitory computer-readable storage medium as claimed in claim 17, further comprising computer program code to cause the apparatus to provide a User Interface (UI) accessing the digital twin for guiding a user for the customer onboarding.

20. (canceled)

21. The method as claimed in claim 1, wherein the digital twin comprises a virtual model of an enterprise operating the site, the method further comprising:
generating, using the digital twin, a customer onboarding workflow comprising onboarding tasks and timelines, the onboarding tasks and timelines being automatically adjusted based on business requirements of a customer associated with the site; and
monitoring, using the digital twin, progress of the customer through the customer onboarding workflow against a plurality of onboarding milestones, and generating an automated notification in response to one of the onboarding milestones being incomplete.

22. The method as claimed in claim 1, wherein the functional relations are determined as mathematical formulae relating the one or more operational parameters, the mathematical formulae including a formula relating the output quantity of the first asset to the input quantity of the first asset and the capacity of the first asset.
